(19) United States
(12) Patent Application Publication
(10) Pub. No.: US 2018/0225928 A1
(43) Pub. Date: Aug. 9, 2018

(54) COMPUTER-IMPLEMENTED TEXAS HOLD'EM POKER VARIANT

(71) Applicant: Bally Gaming, Inc., Las Vegas, NV (US)

(72) Inventor: Roger M. Snow, Las Vegas, NV (US)

(21) Appl. No.: 15/948,981

(22) Filed: Apr. 9, 2018

Related U.S. Application Data
(63) Continuation of application No. 13/631,816, filed on Sep. 28, 2012, now abandoned.
Application No. 13/631,816 is a continuation-in-part of application No. 13/455,742, filed on Apr. 25, 2012.
Application No. 13/455,742 is a division of application No. 11/156,352, filed on Jun. 17, 2005, now abandoned.

(51) Int. Cl. G07F 17/32

(52) U.S. Cl. CPC G07F 17/3293; G07F 17/3276

(57) ABSTRACT

A variant game of Hold 'Em poker allows one or all players to remain in the game with an option of checking or making specific wagering amounts in first play wagers, while limiting the size of subsequent available play wagers or prohibiting the one or all players from making additional play wagers if a first play wager has been made. The one or all players also have at least two and as many as three or four distinct opportunities, in the stages in the play of a hand, to make one or more play wagers.

### CROSS-REFERENCE TO RELATED APPLICATIONS

This application is a continuation of U.S. patent application Ser. No. 13/631,816, filed Sep. 28, 2012, which is a continuation-in-part of U.S. patent application Ser. No. 13/455,742, filed Apr. 25, 2012, which is a divisional of U.S. patent application Ser. No. 11/156,352, filed Jun. 17, 2005, now abandoned, the disclosure of each of which is incorporated herein in its entirety by this reference. This application is indirectly related to U.S. patent application Ser. No. 13/549,969, filed Jul. 16, 2012, which is a continuation of the aforementioned U.S. patent application Ser. No. 11/156,352; and to U.S. patent application Ser. No. 14/082,835, filed Nov. 18, 2013, which is a continuation of the aforementioned U.S. patent application Ser. No. 13/549,969. This application is also related to U.S. patent application Ser. No. 14/034,284, filed Sep. 23, 2013, now U.S. Pat. No. 9,129,487, issued Sep. 8, 2015, which is a continuation-in-part of the aforementioned U.S. patent application Ser. No. 13/631,816; to U.S. patent application Ser. No. 14/846,443, filed Sep. 4, 2015, which is a continuation of the aforementioned U.S. patent application Ser. No. 14/034,284; and to U.S. patent application Ser. No. 14/846,567, filed Sep. 4, 2015, which is a divisional of the aforementioned U.S. patent application Ser. No. 14/034,284.

### FIELD

The present invention relates to wagering games, casino table wagering games, casino table playing card wagering games, computer-implemented wagering games, and variants of casino table wagering games that use poker ranks in determining outcomes.

### BACKGROUND

Many different wagering games presently exist for use in both home and casino environments. Such games should necessarily be exciting, uncomplicated, and easy to learn to avoid frustrating players. Designing new games that meet these criteria and are sufficiently different from old games to entice players to play the new games is a particular challenge.

### SUMMARY

A new variant game of Hold 'Em poker allows one or all players to remain in the game with an option of checking or making specific wagering amounts in first play wagers. For purposes of this disclosure, “checking” means staying in the game without making an additional wager. Games disclosed herein have limits and prohibitions regarding the size of the bets that can be made as the game progresses. Play wagers, if made earlier in the game, can be multiples of later-made play wagers. For example, players may be given the opportunity for making play wagers during at least two different stages of play and may have the opportunity to make a play wager in as many as three or four distinct stages in the play of a single hand. As the game progresses, more information is available to the player, and, consequently, the permitted wager amounts decrease with increasing information.

The games described in this disclosure can offer side wagers that are based on an entire Hold 'Em hand because players may check or make play wagers, in embodiments, and do not fold. When there is no folding of hands, an entire hand can be considered in resolving side wagers.

One embodiment of the game is based upon a five-card hand that uses poker-style rankings. In this game, the player is dealt or otherwise receives less than a full hand, and, using one or more community cards, makes the best possible five-card hand he or she can. Providing more than one community card may provide additional betting opportunities as the community cards are revealed. The game, in one embodiment, is based on five-card poker hand rankings, and, in other embodiments, other poker hand ranking systems are used, such as three-card poker rankings, four-card poker rankings, and seven-card poker rankings.

### BRIEF DESCRIPTION OF THE FIGURES

FIG. 1 shows a perspective view of a prior art format for an automated gaming system.

FIG. 2 shows an overhead view of the prior art format for an automated gaming system of FIG. 1.

FIG. 3 shows a side view of the prior art format for an automated gaming system of FIG. 1.

FIG. 4 shows a block schematic of an electronic configuration of the prior art format for an automatic gaming system of FIG. 1.

FIG. 5 shows a perspective view of a format for an automated gaming system according to one embodiment.

FIG. 6 shows a schematic of a gaming engine useful in the practice of one embodiment.

FIG. 7 shows a schematic of a player station useful in the practice of one embodiment.

FIG. 8 shows a schematic of an embodiment of a game display useful in the practice of one embodiment.

FIG. 9 shows three typical wagering layouts for a casino card table Hold 'Em game according to one embodiment.

FIG. 10 shows a flow diagram for a process according to one embodiment.

FIG. 11 is a schematic block diagram of a gaming system for implementing wagering games according to one embodiment.

FIG. 12 illustrates a block diagram of a gaming system that offers wagering games according to one embodiment.

FIG. 13 is a block diagram of a gaming system providing for live dealer play for a user at a remote user device according to one embodiment.

FIG. 14 is a high-level block diagram of a computer for acting as a gaming system according to one embodiment.

### DETAILED DESCRIPTION

The terms “gaming,” “gambling,” and the like, refer to activities, games, sessions, rounds, hands, rolls, operations, and other events related to wagering games, such as web games, casino games, card games, dice games, and other games of chance for which wagers may be placed by a player. In addition, the words “wager,” “bet,” “bid,” and the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games using real currency, virtual credits, or other countable elements.

The gaming methods described in this disclosure may be played in a number of different formats, such as a live-action casino table gaming format with a live dealer and real playing cards and chips, or with various automated formats with partial (e.g., wagers only) or complete (wagers, cards, dealer, etc.) automation of the format. Such formats include traditional video gaming apparatus and modern multi-player platforms, such as those described in U.S. patent application Ser. No. 10/764,995 (now U.S. Pat. No. 8,272,958), Ser. No. 10/764,994 (now U.S. Pat. No. 7,661,676), and Ser. No. 10/764,827 (now abandoned), each filed on Jan. 26, 2004, which are hereby incorporated by reference, the apparatus of each of which is described in more detail in the disclosure below.

A basic format (whether on a table or automated device, with computer, processor, monitor, cash/credit/token receptors, etc.) of play involves a player making at least a first ante wager to enter the game against a dealer hand. The dealer and players each receive at least one card. In one example of the game, the dealer provides two cards to each player who made an ante wager and provides two cards to the dealer. The player cards may be face up or face down. Providing the player cards face down may be preferable to the players and also preferable to the house. Typically, the dealer and the players each receive the same number of cards; however, a game can include dealing unequal numbers of cards to the dealer and to the players, which will alter the house advantage. For example, giving the dealer three cards, instead of two cards, and allowing the dealer to discard one card would provide a greater advantage to the house.

One example of the game play described herein is referred to as “ULTIMATE TEXAS HOLD 'EM”®. To begin the game, players make at least one ante wager or, preferably, at least two initial equal wagers, namely an ante wager and a blind wager. The ante wager is mandatory to participate in this embodiment of the game. In one form of the game, the blind wager is also mandatory. A bonus wager is optional (called the “trips” wager) and is based on the player's resulting best five-card hand having an ultimate hand rank of at least a three-of-a-kind. Other higher-ranking hands also pay bonus payouts according to a pay table listing winning hand outcomes and corresponding payout odds. The minimum hand of a three-of-a-kind is selected based on the mathematics of the game and is a matter of design choice. In this example of the game, the dealer deals each player two hole cards face down. The dealer receives a two-card dealer hand of two hole cards (face down). This two-card hand may be dealt at the same approximate time as the player hand or nearer the end of the game, after all wagers have been placed and the player has seen all available cards.

In one embodiment, after viewing the hole cards, players may make a single play wager that may be made at different predetermined stages in the progression of the hand. Furthermore, an amount of the play wager may vary with the stage of progression of the hand of the game. In one example, the player can make the play wager only once and can make the play wager at up to four different stages in the progress of the game. With each passing step, the amount of the permitted play wager decreases. The player is, therefore, rewarded for risking larger amounts earlier in the game, when less information about the outcome of the hand is available for the player. As the player learns additional information about whether the player is likely to win the wager, the player is able to wager less money on the play wager.

The game rules also set limits on the amount of each possible play wager. For example, in the early stages of a round, the play wager can be chosen from within a range, such as 1× to 10×, 1× to 6×, or 1× to 4× the ante wager, for example. At the last stage, the play wager may be limited to no more than 1× the ante wager. Depending upon the stage of the game when the play wager is made, with earlier stages allowing larger play wagers and later stages allowing for relatively smaller play wagers, higher payouts can be made to a player who puts more at risk when less information is available.

In this example, after seeing their two hole cards, players have a specific choice: check (remaining in the game) or making a specific play wager amount (e.g., precisely a 4× wager). In other examples, rather than a specific play wager amount, the player may choose a bet within a range of wagers (e.g., between 1× and 10×). The “x” indicates a multiple of the ante wager. In one embodiment, players may not fold. The player is allowed to see additional card(s) that may well improve an apparently weak hand and decide at that time to place a play wager. When no folding is permitted, the range of payouts on the side wagers can be increased because it becomes possible to use a complete hand of cards in determining winning outcomes.

The dealer then displays (deals or reveals) the first set of community cards. In one embodiment, the first set of community cards is three community cards out of a total of five community cards. In other embodiments, more or fewer than five cards are dealt as community cards, and the initial display of community cards may also be adjusted.

In one example of the game, before any community cards are revealed, the players know only two out of seven cards (i.e., the player's initial hand) the player may use to form a hand. After the initial set of three community cards is revealed, players know the identity of five out of the seven. When the fourth community card is revealed, players know six out of the seven cards, and, when the last community card is turned over, players know all seven and can pick the best five cards. The first three cards in Hold 'Em games are typically referred to as the “flop.” The fourth card is referred to as the “turn card” or simply “the turn,” and the fifth community card is referred to as the “river card” or simply “the river.”

After seeing the first set of community cards, the players have the following options. If they have not already made the first play wager (e.g., the specific amount wager such as the 4× play wager), they may again check (remaining in the game without wagering at this time) or make a second play wager of an amount less than the amount of the first play wager, such as 2× or 3× the ante wager for the second play wager. If the player made the original, first play wager, e.g., the 4× play wager, the player may not make an additional play wager and must check for the remainder of the game. In this example of the game, players cannot fold. In some embodiments, additional play wagers may be made in smaller amounts for the player who has made an original play wager. Typically, no action, other than a check, can be made by the player who made the original (4×) play wager at this point; although, in other examples of the game, folding or a surrender can also be allowed.

Players may also have a choice to play a range of play wagers, such as from 1× to 4× the ante wager in the first play wager, and 1× to 3× the ante wager in the second play wager, etc.

The dealer then displays additional community cards, up to the total number of community cards, depending on the embodiment, such as both of the remaining community cards (the turn and the river). Another embodiment would allow an additional wager with the fourth, but not the fifth, community card revealed where the player has not previously made a play wager. An example of such a wager could be 2× or 3× the ante wager or a range of 1× to up to 3× the ante wager. In one embodiment, play wagers are allowed after the first two player cards are revealed, after the flop is revealed, after the fourth community card is revealed, and after the fifth community card is revealed, for a total of four play wager opportunities.

Players now know all seven of the cards from which each player may make his or her best five-card hand. If the player has made no play wagers in the previous steps, the player may have an additional opportunity to make a play wager (e.g., in one embodiment, 1× the ante wager) or fold. If the player has made a previous play wager, the player may check. In one embodiment, a player who has previously made a play wager may also fold or may be allowed to surrender a portion of the player's bet.

The dealer then reveals his two hole cards to determine the dealer's best five-card hand using the dealer's hole cards and the community cards. In one example, players are free to use any five of the seven available cards to form a player hand. Alternatively, players may be required to use their hole cards, the three highest-ranking community cards, or four community cards and one player hole card. Many other minor rule variations for generating a five-card hand may be implemented without departing from the scope of this disclosure.

The dealer's best five-of-seven-cards hand is compared against each player's best five-of-seven-cards hand to determine head-to-head winners. In one embodiment, no dealer or player qualifying step is necessary to play the game. In an alternative embodiment, the dealer and/or players must qualify with a predetermined minimum card ranking in order to play. If the dealer, for example, does not qualify with any pair or better, for example, the ante wagers are returned to the players. However, the play wagers, blind wagers, and any side wagers are resolved in the normal manner. Play wagers are resolved in the normal manner. All winning payouts on side wagers are still paid, regardless of whether the dealer qualifies. All automatic bonus payouts are also made. When there is no dealer or player qualification step, then the dealer hand is compared to player hands, and the highest-ranking hand wins the round. Ante wagers are paid even money. Blind wagers are paid odds for certain high-ranking hands, and side wagers are paid odds according to a pay table.

A player also wins 1:1 on play wagers when the player hand beats the dealer hand, and ties are pushes. The player loses the ante wager and all play wagers when the player hand has a lower rank than the dealer hand.

The blind wager is typically equal to the ante wager; however, in other embodiments, the blind wager can be a multiple of the ante wager. The blind wager may be mandatory. The blind wager wins when the player has a predetermined winning hand rank, for example, a flush or higher, and the player hand beats the dealer hand. The blind wager loses when the player hand loses. The blind wager pushes when the player hand ties the dealer hand. The blind wager also pushes when the player hand is less than a flush but beats the dealer hand.

Distinct pay tables may be provided for the blind and trips wagers, such as the following:

| Blind payouts | |
|---|---|
| Royal flush | 200:1 |
| Straight flush | 50:1 |
| Four-of-a-kind | 10:1 |
| Full house | 2:1 |
| Flush | 3:2 |
| Trips payouts | |
| Royal flush | 50:1 |
| Straight flush | 40:1 |
| Four-of-a-kind | 30:1 |
| Full house | 8:1 |
| Flush | 7:1 |
| Straight | 4:1 |
| Three-of-a-kind | 3:1 |

The following is an example of a hand of play of the ULTIMATE TEXAS HOLD 'EM® poker embodiment. In ULTIMATE TEXAS HOLD 'EM®, players place at least an ante wager and a blind wager of equal value, as well as an optional trips wager. Two cards are initially dealt to each player and to the dealer. Five community cards are used, and they are revealed in two steps. The first step reveals the first three community cards, and the second step reveals the last two community cards. Until all of the community cards are revealed, players may check (place no wagers) or may place a play wager. The players in ULTIMATE TEXAS HOLD 'EM® may place only a single play wager during the course of the game. As cards are revealed, the amount allowed for the play wager decreases. Prior to revealing any community cards, the players in ULTIMATE TEXAS HOLD 'EM® may make a play wager of either 4× or 3× the ante wager or the player may check. After the first three community cards are revealed, players may make a play wager of exactly 2× the ante wager or the player may check. When the remaining two community cards are revealed, players may make a play wager of exactly 1× the ante wager or the player may fold. If the player has placed a play wager, the player's poker hand is determined by making the best five-card poker hand among the player's two cards and the five community cards. The dealer's poker hand is determined by making the best five-card poker hand among the dealer's two cards and the five community cards. Wagers are resolved based on the player's five-card poker hand and the dealer's five-card poker hand and, for the blind and trips wagers, based on a pay table for qualifying hands. An example follows:

| Dealer Activity | Player 1 Activity | Player 2 Activity |
|---|---|---|
| Awaits wagers | $5 ante, $5 blind | $10 ante, $10 blind, |
| | | $5 trips |

The dealer's partial hand of two cards is dealt face down to the dealer, and each of Player 1 and Player 2 receives his or her partial hand of two cards each. The cards may be face down, face up, or partially exposed for the players.

| Dealer Activity | Player 1 Activity | Player 2 Activity |
|---|---|---|
| Cards hidden | 10 [symbol] , Jack [symbol] | King♥, King♦ |

After viewing their initial partial two-card hands, the players may make their decision on the first play wager. Player 1's hole cards are good, but do not warrant a large wager. If given a choice between a check and up to the extreme of 4× the ante wager, Player 1 would elect to check. He chooses to check because he does not have enough information to determine whether his hand is strong enough to win. Player 2's hand is very good, although it still has not reached a bonus level payout (e.g., three-of-a-kind or better, or at least a straight), but the hand probably warrants the maximum first play wager of 4× the ante wager, i.e., an additional $40.00 wagered. In this embodiment, Player 2 may not make any further wagers, and Player 2 checks until the completion of the round.

After conclusion of this first play wager round of wagering, the flop (three community cards) is shown. Those cards, in this example, are:
King [symbol] , Queen♦, and 7 [symbol] .

These cards provide Player 1 with an outside (two-way) straight draw and two running cards for a club flush, with two cards remaining to be drawn. This hand is considered a relatively good hand. Player 1, who has not yet made a play wager, might, therefore, elect to make the maximum second play wager of 2× the ante wager, i.e., $10.00. As noted earlier, in this example, Player 2 has no further wagers available, but Player 2 would be happy with the flop, which provided a rank of three-of-a-kind at this stage.

| Dealer Activity | Player 1 Activity | Player 2 Activity |
|---|---|---|
| Cards hidden | $10, 2× second play | $40, 4× first play |
| | wager opportunity | wager opportunity |

At this point, in the example method of play, the last two community cards are revealed. In this example, the community cards are:
7♦ and 4♥.

At this point, the rank of Player 1's hand is a pair of sevens, and the rank of Player 2's hand is a full house.

As both players have made play wagers at this time, if the rules limit player activity to a single play wager during the progress of a hand, no further play wagers may be made. If Player 1 had been conservative in the second play wager stage and checked, then Player 1 might be required to make a third play wager of 1× to remain in the game, may be allowed to check, or may be allowed to fold at this stage. Having made the earlier second play wager, Player 1 would have no choice but to check at this point. If allowed, Player 2 might make an additional wager.

At this point, the dealer would reveal the two cards in the dealer's partial hand. Although it is common for the dealer's two-card partial hand to have been dealt at the same time as the players' partial hands and to have been kept face down, as a security measure (preventing any possibility of those dealer cards having been exposed or partially exposed) the dealer's two cards might be dealt at the end of play, i.e., at this point in the play of the hand of the game.

The dealer's cards are 10♥, and Jack♦. This dealer hand is, in combination with the community cards, identical with the rank of Player 1's hand; therefore, the ante wager is a push according to the rules of play. The blind wager loses.

Player 2's hand rank, as a full house, wins 1:1 on the ante wager ($10), wins 1:1 on the 4× first play wager ($40), wins 2:1 ($20) on the blind wager, and wins 8:1 ($40) on the trips wager for a total win of $110.

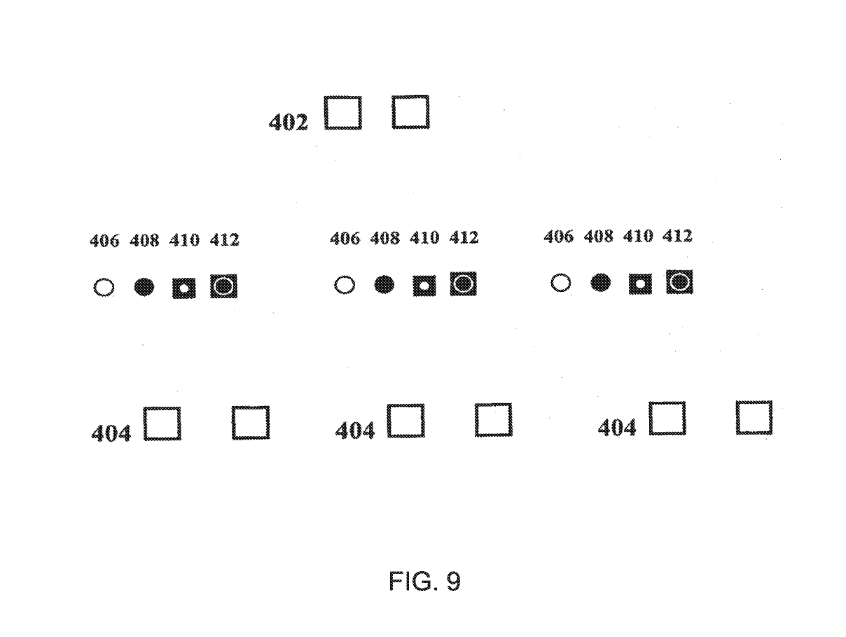

A betting layout for ULTIMATE TEXAS HOLD 'EM® poker games is shown in FIG. 9. A dealer hand 402 of two cards is shown, and player hands 404 for three players are also shown. Each player's position is provided with four separate betting areas, namely an ante wager area 406, a blind wager area 408, a trips wager area 410, and a play wager area 412. As there may be only a single play wager made during the play of the game, in these embodiments a single play wager area 412 is provided. The presence or absence of a token or coin in that play wager area 412 at any time may indicate the status and opportunity of players to make play wagers and the amount of play wagers at the various stages of the games. For example, when the flop has been exposed, if there is no wager present in the play wager area 412, then the lack of a play wager indicates that a) the player can still make a play wager and b) the player is known to have specific ranges or amounts of the second play wager available to that player. In contrast, if a wager is present, then the player is known to have no second play wager available at that stage of the game.

Additional wagering areas may be used if additional wagers are allowed. For example, the game rules might allow four different opportunities to make a play wager, and a different wagering circle (and wagering limits) might be provided for each stage of the game. For example, if a player has placed the 4× first play wager, the rules of the game may be modified to allow for additional wagers at the same or at lower odds than the earlier play wagers. If the rules of the game allow for multiple play wagers, it would be desirable to provide multiple wagering circles on the layout. For example, if Player 2 in the example had received a flop of a king and a pair, or two additional kings, he might be allowed to make an additional wager in one embodiment. The rules of the game might allow for one additional play wager at the same 1:1 odds, or allow subsequent wagers to be placed at lower odds, such as 1:2 odds, returning an additional 50% on the second play wager.

Other embodiments are also contemplated. For example, a four-card version of the game could be offered in which each player and the dealer receive one card, and the dealer deals three or four community cards. Players can bet up to 3× the ante wager after viewing the first card, up to 2× the ante wager after seeing the first two community cards, and up to 1× the ante wager after seeing all of the cards.

An interesting aspect is that, in a form of play as described above, players either check or raise during various stages of play of a Hold 'Em style poker game, but the players are not permitted to fold until the end. This rule enables play of a side wager based on the composition of the entire final hand of cards. In typical Hold 'Em games, players fold before all of the cards are revealed, making it impossible to base side wager results on a five-card hand, for example. Five-card outcomes have a wider variety of probabilities and allow for game designs offering higher payouts for less frequently occurring hands, such as obtaining a five-card royal flush, for example.

Another feature of this embodiment is that players are permitted to place wagers on a hand after all of the community cards are revealed. This feature allows a player to know the player's five-card hand prior to placing a final bet and may have appeal to a player who prefers certainty about the strength of the player hand before making a bet.

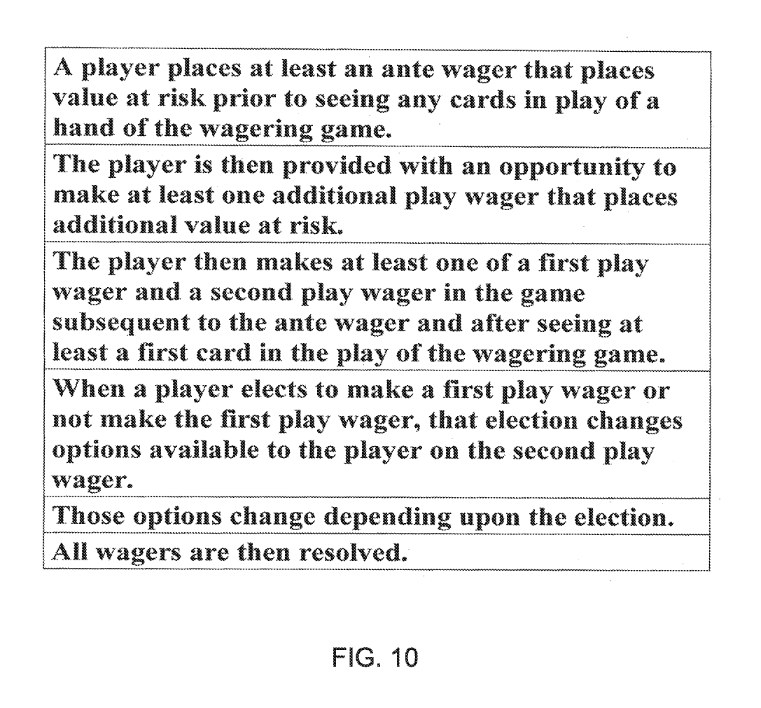

FIG. 10 shows a flow diagram for a process according to one embodiment. As shown by the diagram, a player initially places at least an ante wager that places the ante wager value at risk prior to seeing any cards in play of a hand of the wagering game. Next, the player is provided an opportunity to make at least one additional play wager that places additional value at risk. The player may make at least one of a first play wager and a second play wager in the game subsequent to the ante wager, after seeing at least a first card. After deciding whether to make the first play wager, the election of the first play wager changes the options available to the player on the second play wager. For example, after making the first play wager, the player may be required to check at the second play wager opportunity. However, if the player did not make the first play wager, the player may be allowed to make the second play wager. Therefore, based on the first play wager election, options for the second play wager change. Any remaining cards are dealt, and the wagers are then resolved.

The games of the present disclosure may be implemented as live table games, as television or cable game show games, on video poker gaming machine platforms, as hand-held games for play, as multiple player interactive wagering platform games (with kiosk formats, single player screens, community screens, and/or banks of seats for players with a common dealer screen), as cell phone games, as games downloadable from the internet, as parlor games, as games executed on a personal computer, a palm pilot, or a PLAYSTATION®, and the like. Each of the above game applications is a way to play the game.

A gaming system that can be used to practice the games described herein comprises a table and a dealer “virtual” video display system positioned for view by players seated at the table. The table may seat at least two players, up to the amount of players that can be configured about the table and have a view of the dealer video display system. Typically, each gaming system will have available at least four player positions, with space determinations considered as to whether there would be four, five, six, or seven player positions. It is possible to have a completely circular dealer display (e.g., holographic display in a cylindrical centerpiece) and have players distributed around the entire periphery. A surface of the table will include a generally continuous common display surface for showing all player hands, community cards, dealer hands, and any other cards or game pieces used to play the game for any purpose, and, where there are touch screen player controls, for displaying the player touch screen controls. A majority of the table surface comprises a video monitor in one embodiment. Where there are no touch screen controls, the table surface may include player control panels at each player station near the continuous common display surface. The use of a continuous common display surface offers some significant advantages in simulating or recreating a standard card table surface. Cards may be readily viewed by other players at a table, which is standard in table games and adds to player enjoyment. Individual monitors, especially where slanted toward the individual players, make such table-wide card reading difficult. The use of the full screen (continuous) display also allows for better animation to be provided, such as displaying virtual images of cards moving to the player and “virtual” chips being placed on the table when wagers are indicated. For purposes of this disclosure, the term “virtual” means a graphical video representation of a real object or person, such as a dealer, cards, and chips, for example.

The individual player positions preferably have a separate intelligence at each player position that accepts player input and communicates directly with a game engine (main game computer or processor). The intelligence is preferably an intelligent board that can process information. For purposes of this disclosure, the term “intelligent” refers to the ability to execute code, provided in the form of software, hardware circuits, or both. Such processing may at least comprise some of signal converting (e.g., signals from player card readers, credit deposits, currency readers, coin readers, touch screens, control panels) into a signal that can be included in an information packet and interpreted by the main game computer when the signal is sent. Communication between the intelligence at each player position is direct to the main game computer and may be by self-initiated signal sending, sequenced polling by the main game computer (e.g., each position communicates directly to the main game computer in turn), timed communication, or any other order of communication that is direct between the intelligence and the main game computer.

One form of communication between the main game computer and player station computers is by means of self-initiated signal sending. There is essentially a single main game computer that contains video display controls and programs for both the dealer display and the table surface display, audio controls and programs, game rules (including storage of multiple games if intended to be available on the machine), a random number generator, graphic images, game sequence controls, security systems, wager accounting programs, external signaling and audit functions, and the like. In other embodiments, the above functions are divided between a main processor and one or more additional processors. The intelligence at each player position speeds up the performance of all aspects of the game by being able to communicate directly with the main game computer and by being able to process information at the player position rather than merely forwarding the information in raw form to the main game computer. Processing player information at player positions frees up resources for use by the main processor or processors.

A card game system may also include a suitable data and control processing subsystem that is largely contained within a main control module supported beneath the table surface. The control and data processing subsystem includes a suitable power supply for converting alternating current from a power main as controlled by a main power switch. The power supply transforms the alternating line current to a suitable voltage and to a direct current supply. Power is supplied to a power distribution and sensor/activity electronics control circuit. Commercially available power switching and control circuits may be provided in the form of a circuit board that is detachable and plugs into a board receptacle of a computer motherboard or an expansion slot board receptacle. A main game controller motherboard may include a central microprocessor and related components well-known in the industry as computers using Intel brand PENTIUM® microprocessors and related memory or intelligence from any other manufacturing source. A variety of different configurations and types of memory devices can be connected to the motherboard. Of particular interest is the inclusion of two flat panel display control boards connected in expansion slots of the motherboard. Display control boards are each capable of controlling the images displayed for the dealer video display and for each of the player position display areas on the continuous display screen on the table and other operational parameters of the video displays used in the gaming system. More specifically, the display control boards are connected to player bet interface circuits for the player stations. This arrangement also allows the display control boards to provide necessary image display data to the display electronic drive circuits associated with the dealing event program displays and the dealer display.

The motherboard and/or the individual player intelligent boards also include a serial port that allows stored data to be downloaded from the motherboard to a central casino computer or other additional storage device. In one example, each player board communicates directly with the casino computer system. This allows card game action data to be analyzed in various ways using added detail, or by providing integration with data from multiple tables so that cheating schemes can be identified and eliminated and player tracking can be maintained. Player performance and/or skill can be tracked at one table or as a compilation from gaming at multiple tables, as by using BLOODHOUND™ security software marketed by Shuffle Master, Inc., which software may be incorporated into this automated gaming system. Additionally, player hand analysis can be performed. The motherboard and/or individual player intelligent boards may also have a keyboard connection port that can be used to connect a larger format keyboard to the system to facilitate programming and servicing of the system.

Although the system shown does not require features illustrated for receiving automated player identification information, such features can alternatively be provided. Card readers, such as those used with credit cards or other identification code reading devices, can be added in the system to allow or require player identification in connection with play of the card game and associated recording of game action by one of the processors. Such a user identification interface, for example, a card reader located at each player station, can be implemented in the form of a variety of magnetic card readers commercially available for reading user-specific identification information. The user-specific information can be provided on specially constructed magnetic cards issued by a casino or on magnetically coded credit cards or debit cards frequently used with national credit organizations, such as VISA®, MASTERCARD®, AMERICAN EXPRESS®, casino player card registries, banks, and other institutions. The information could also be provided on other writable media, such as an RFID chip with writable memory or bar coding, as just a couple examples.

Alternatively, it is possible to use so-called smart cards to provide added processing or data storage functions in addition to mere identification data. For example, the user identification could include coding for available credit amounts purchased from a casino. As a further example, the identification card or other user-specific instrument may include specially coded data indicating security information such as would allow accessing or identifying stored security information that must be confirmed by the user after scanning the user identification card through a card reader. Such security information might include such things as file access numbers that allow the central processor to access a stored security clearance code that the user must indicate using input options provided on displays using touch screen displays. A still further possibility is to have participant identification using a fingerprint image, eye blood vessel image reader, or other suitable biological information to confirm identity of the user that can be built into the table. Still further, it is possible to provide such participant identification information by having the pit personnel manually code in the information in response to the player indicating his or her code name or real name. Such additional identification could also be used to confirm credit use of a smart card or transponder. All or part of the functions dedicated to a particular player station are controlled by the player station intelligence in one embodiment. Additionally, each player station intelligence may be in communication with a casino accounting system.

It should also be understood that the continuous screen can alternatively be provided with suitable display cowlings or covers that can be used to shield display of card images from viewing by anyone other than the player in games where that is desirable. This shielding can also be effected by having light-orientation elements in the panel, and some of these light-orientation elements are electronically controllable. In this manner, the processor can allow general viewing of cards in games where that is desirable or tolerated and then alter the screen where desired. These types of features can be provided by nanometer micrometer, or other small particulate or flake elements within a panel on the viewing area that are reoriented by signals from the processor. Alternatively, liquid crystal or photo chromatic displays can be used to create a screening effect that would allow viewers at only specific angles of view from the screen area to view the images of cards. Such an alternative construction may be desired in systems designed for card games different from blackjack, where some or all of the player or dealer cards are not presented for viewing by other participants or onlookers. Such display covers or cowlings can be in various shapes and configurations as needed to prevent viewing access. It may, alternatively, be acceptable to use a player-controlled switch that allows the display to be momentarily viewed and then turned off. The display can be shielded using a cover or merely by using the player's hands. Still further, it is possible to use a touch screen display that would be controlled by touch to turn the screen on and to turn the screen off. Similar shielding can be used to prevent others from viewing the display.

A review of the figures will assist in describing various embodiments.

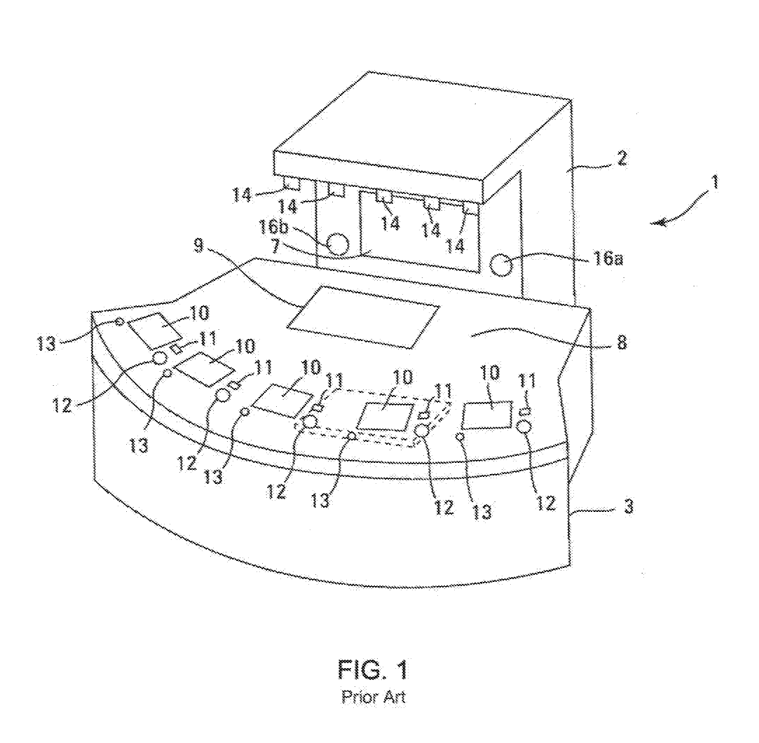

FIG. 1 shows a fully automated gaming system 1 of the prior art, as disclosed in U.S. Patent Application Publication No. 2003/0199316 (now U.S. Pat. No. 7,128,651), which is hereby incorporated by reference. The automated gaming system 1 comprises a vertical upright display cabinet 2 and a player bank (or station cluster) arrangement 3. The vertical upright display cabinet 2 has a viewing screen 7 on which images of a virtual dealer are displayed. A top 8 of the player bank arrangement 3 has individual monitor screens 10 for each player position, as well as tabletop inserted coin acceptors 11 and player controls 12 and 13. There is a separate and larger dealer hand screen 9 on which dealer cards are displayed in a format large enough for all players to view. Speakers 16a and 16b are provided for sound transmission, and decorative lights 14 are provided.

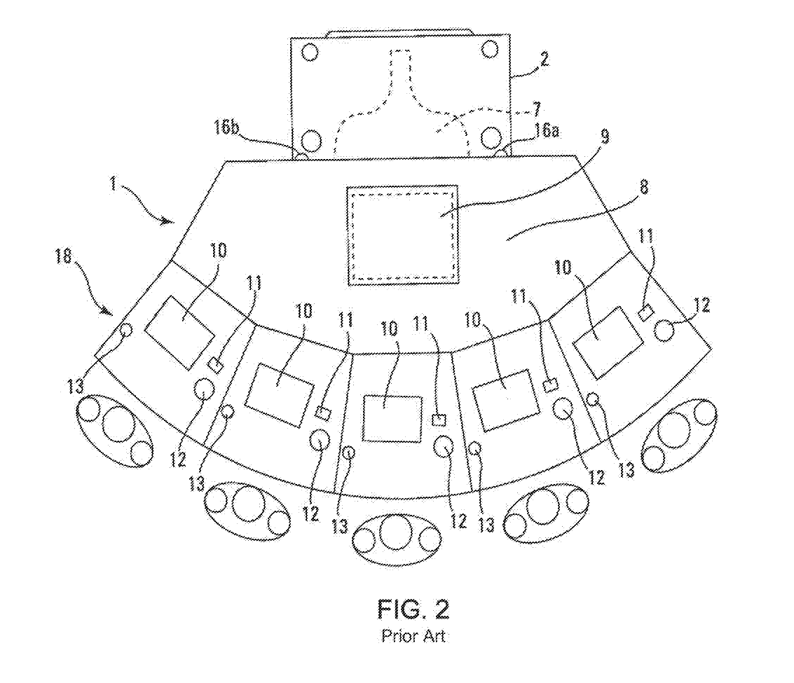

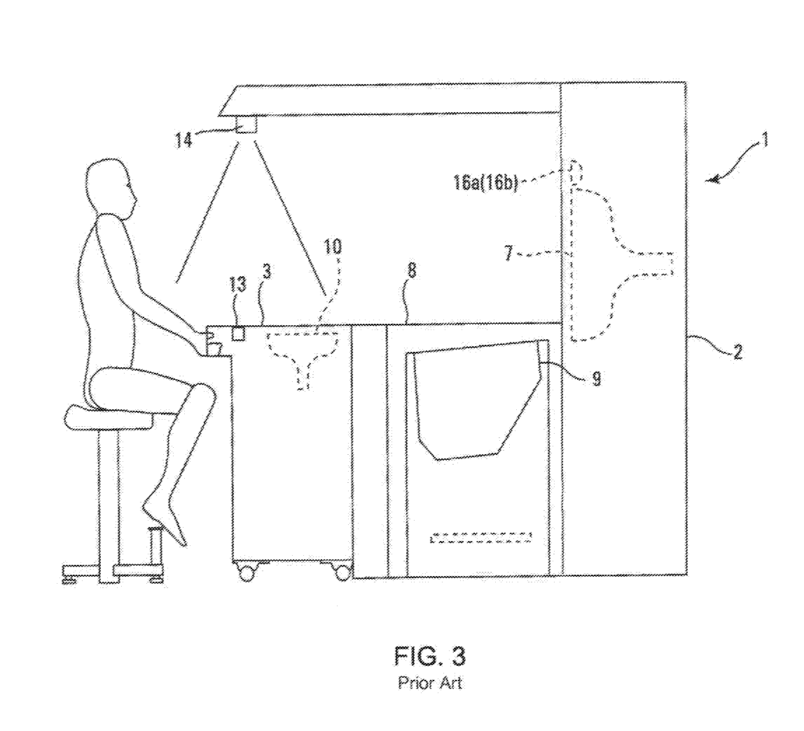

FIG. 2 shows an overhead view of the same prior art automated gaming system 1 with the viewing screen 7 shown more clearly as a CRT monitor. It can also be seen that each player position has to form an arc cut into the semicircular player seating area 18. FIG. 3 shows a side view of the same prior art automated gaming system 1 of FIGS. 1 and 2 where the orientation of three different types of CRT monitors (the viewing screen 7, the dealer hand screen 9, and the individual monitor screens 10) are shown.

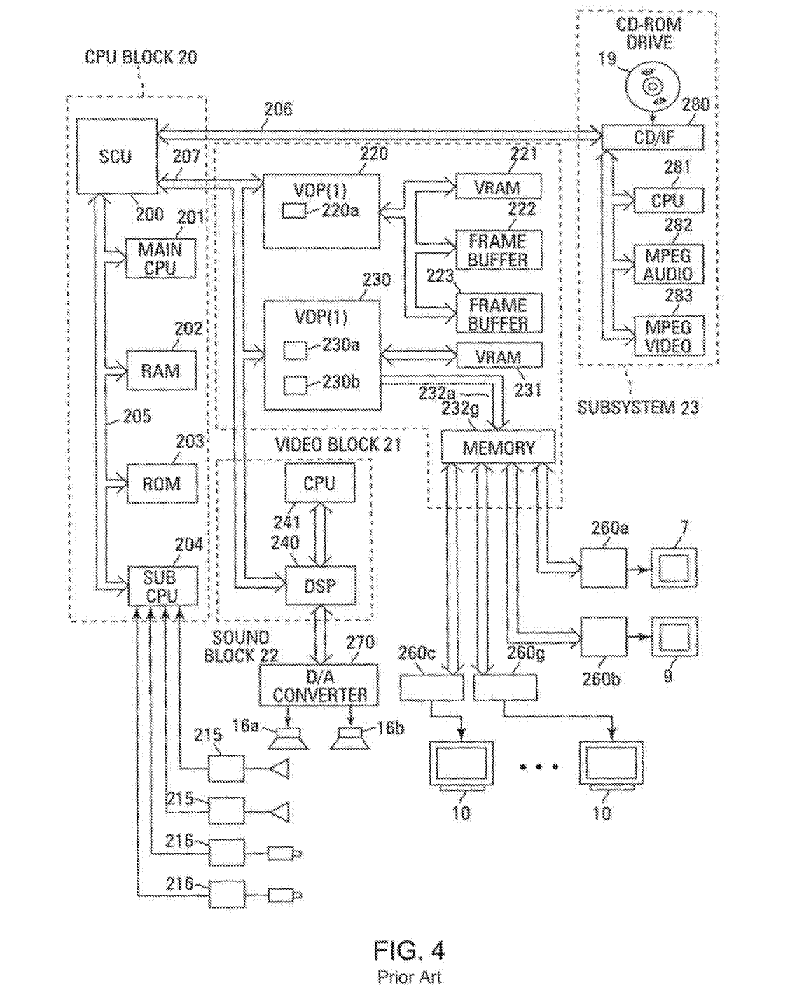

FIG. 4 shows the schematic circuitry of a prior art automated system as disclosed in U.S. Patent Application Publication No. 2003/0199316 (now U.S. Pat. No. 7,128,651). FIG. 4 is a block diagram of processing circuitry in the automated gaming system 1 of FIG. 1. A game device housing comprises a CPU block 20 for controlling the whole device, a video block 21 for controlling the game screen display, a sound block 22 for producing effect sounds and the like, and a subsystem 23 for reading out CD-ROM.

The CPU block 20 comprises an SCU (System Control Unit) 200, a main CPU 201, RAM 202, ROM 203, a sub-CPU 204, and a CPU bus 205. The main CPU 201 contains a math function similar to a DSP (Digital Signal Processor) so that application software can be executed rapidly.

The RAM 202 is used as the work area for the main CPU 201. The ROM 203 stores the initialization program used for the initialization process. The SCU 200 controls the CPU bus 205 and busses 206 and 207 so that data can be exchanged smoothly among VDPs (e.g., a first VDP 220 and a second VDP 230), a DSP 240, and other components.

The SCU 200 contains a DMA controller, allowing data (polygon data) for character(s) in the game to be transferred to VRAM in the video block 21. This allows the game machine or other application software to be executed rapidly. The sub-CPU 204 is termed an SMPC (System Manager and Peripheral Control). Its functions include collecting sound recognition signals from a sound recognition circuit 215 or collecting image recognition signals from an image recognition circuit 216 in response to requests from the main CPU 201. On the basis of sound recognition signals or image recognition signals provided by the sub-CPU 204, the main CPU 201 controls changes in the expression of the character(s) appearing on the game screen or performs image control pertaining to game development, for example. The video block 21 comprises the first VDP (Video Display Processor) 220, for rendering TV game polygon data characters and polygon screens overlaid on a background image, and a second VDP 230, for rendering scrolling background screens, performing image synthesis of polygon image data and scrolling image data based on priority (image priority order), performing clipping, and the like. The first VDP 220 houses a system register 220a and is connected to VRAM (DRAM) 221 and to two frame buffers 222 and 223. Data for rendering the polygons used to represent TV game characters and the like is sent to the first VDP 220 through the main CPU 201, and the rendering data written to the VRAM 221 is rendered in the form of 16- or 8-bit pixels to the rendering frame buffer 222 (or 223). The data in the rendered frame buffer 222 (or 223) is sent to the second VDP 230 during display mode. In this way, frame buffers 222 and 223 are used as frame buffers, providing a double buffer design for switching between rendering and display for each individual frame. Regarding information for controlling rendering, the first VDP 220 controls rendering and display in accordance with the instructions established in the system register 220a of the first VDP 220 by the main CPU 201 via the SCU 200.

The second VDP 230 houses a register 230a and color RAM 230b and is connected to VRAM 231. The second VDP 230 is connected via the bus 207 to the first VDP 220 and the SCU 200 and is connected to picture output terminals through memories 232a through 232g and encoders 260a through 260g. The picture output terminals are connected through cables to the viewing screen 7 and the individual monitor screens 10.

Scrolling screen data for the second VDP 230 is defined in the VRAM 231 and the color RAM 230b by the main CPU 201 through the SCU 200. Information for controlling image display is similarly defined in the second VDP 230. Data defined in the VRAM 231 is read out in accordance with the contents established in the register 230a by the second VDP 230 and serves as image data for the scrolling screens that portray the background for the character(s). Image data for each scrolling screen and image data of texture-mapped polygon data sent from the first VDP 220 is assigned display priority (priority) in accordance with the settings in the register 230a, and the final image screen data is synthesized.

Where the display image data is in palette format, the second VDP 230 reads out the color data defined in the color RAM 230b, in accordance with the values thereof, and produces the display color data. Color data is produced for each display (the viewing screen 7 and the dealer hand screen 9) and for each satellite display (the individual monitor screens 10). Where display image data is in RGB format, the display image data is used, as-is, as display color data. The display color data is temporarily stored in the memories 232a through 232g and is then output to the encoders 260a through 260g. The encoders 260a through 260g produce picture signals by adding synchronizing signals to the image data, which is then sent via the picture output terminals to the viewing screen 7 and the individual monitor screens 10. In this way, the images required to conduct an interactive game are displayed on the viewing screen 7 and the individual monitor screens 10.

The sound block 22 comprises the DSP 240, for performing sound synthesis using PCM format or FM format, and a CPU 241, for controlling the DSP 240. Sound data generated by the DSP 240 is converted into two-channel sound signals by a D/A converter 270 and is then presented to audio output terminals via an interface. These audio output terminals are connected to the input terminals of an audio amplification circuit. Thus, the sound signals presented to the audio output terminals are input to the audio amplification circuit (not shown). Sound signals amplified by the audio amplification circuit drive the speakers 16a and 16b. The subsystem 23 comprises a CD-ROM drive 19, a CD-I/F 280, and CPU 281, an MPEG-AUDIO section 282, and an MPEG-VIDEO section 283. The subsystem 23 has the function of reading application software provided in the form of CD-ROM and reproducing the animation. The CD-ROM drive 19 reads out data from the CD-ROM. The CPU 281 controls the CD-ROM drive 19 and performs error correction on the data read out by it. Data read from the CD-ROM is sent via the CD-I/F 280, the bus 206, and the SCU 200 to the main CPU 201, which uses it as the application software. The MPEG-AUDIO section 282 and the MPEG-VIDEO section 283 are used to expand data that has been compressed in MPEG (Motion Picture Expert Group) format. By using the MPEG-AUDIO section 282 and the MPEG-VIDEO section 283 to expand data that has been compressed in MPEG format, it is possible to reproduce motion picture. It should be noted herein that there are distinct processors for the CPU block 20, the video block 21, the sound block 22, the CD-ROM drive 19, and memory with their independent CPUs. This requires significant computing power and still has dumb (no intelligence) player input components.

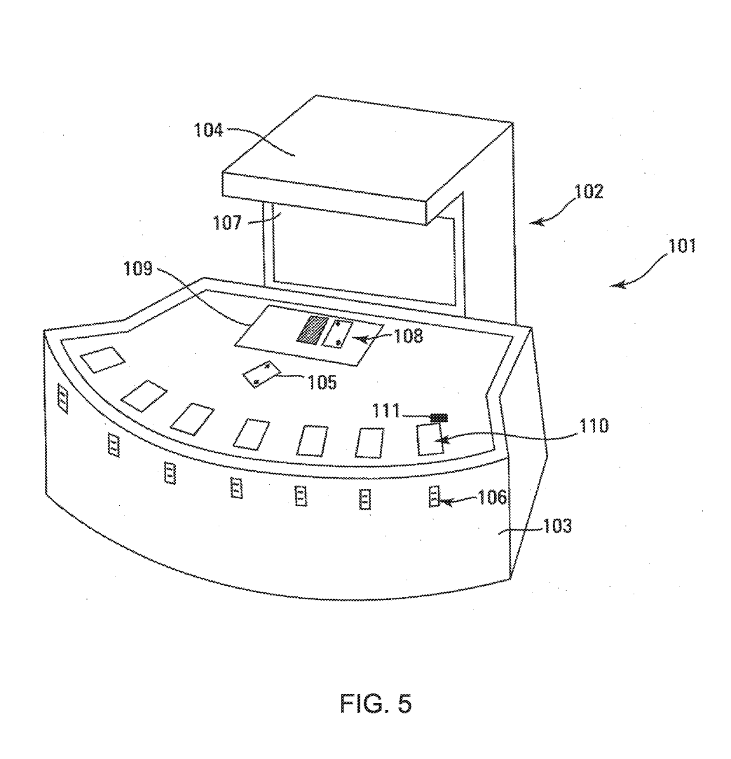

FIG. 5 shows an example of an automated table system 101 useful to practice the game play methods according to one embodiment. The system 101 has an upright dealer display cabinet 102 with a top 104 and a dealer viewing screen 107, which may be any form of display screen, such as a CRT, a plasma screen, a liquid crystal screen, an LED screen, or the like. A player bank arrangement 103 has a continuous display screen 109 on which images of cards 105 being dealt, dealer's cards 108, bets wagered 111, and touch screen player input functions 110 are displayed. Other player input functions may be provided on a panel 106, which might accept currency, coins, tokens, identification cards, player tracking cards, ticket in/ticket out acceptance, and the like.

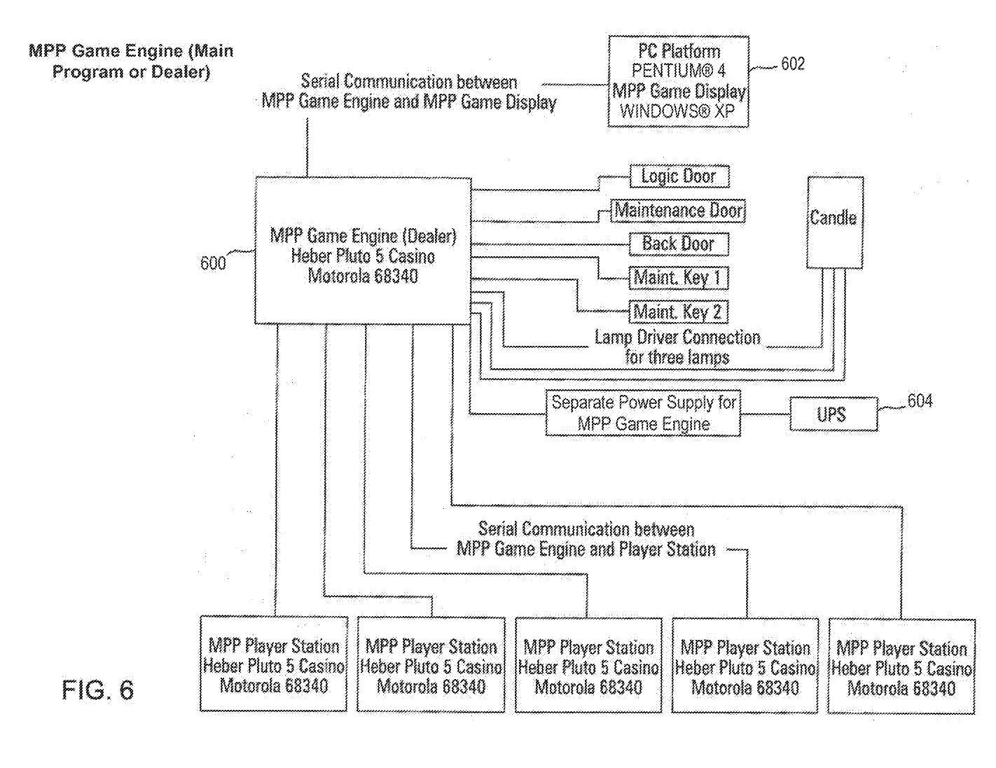

FIG. 6 shows an electronic/processor schematic for a MultiPlayer Platform (MPP) gaming system according to an embodiment. The MPP game engine (dealer) comprises a Heber Pluto 5 casino game board 600 (Motorola 68340 board) operating off the PC Platform PENTIUM® 4 MPP game display processor 602. The game display processor 602 operates on a WINDOWS® XP platform. The respective subcomponents on the PENTIUM® 4 MPP game display processor 602 are labeled to show the apportionment of activity on the motherboard and the component parts added to the motherboard. As is shown, the game engine has an uninterruptible power supply 604. The game display processor 602 directs activity on the speakers, directs activities onto the MPP game service panel, and directs activities onto the plasma monitor card display. It is important to note that all communications are direct from the game display processor 602, freeing up resources available to the game engine processor.

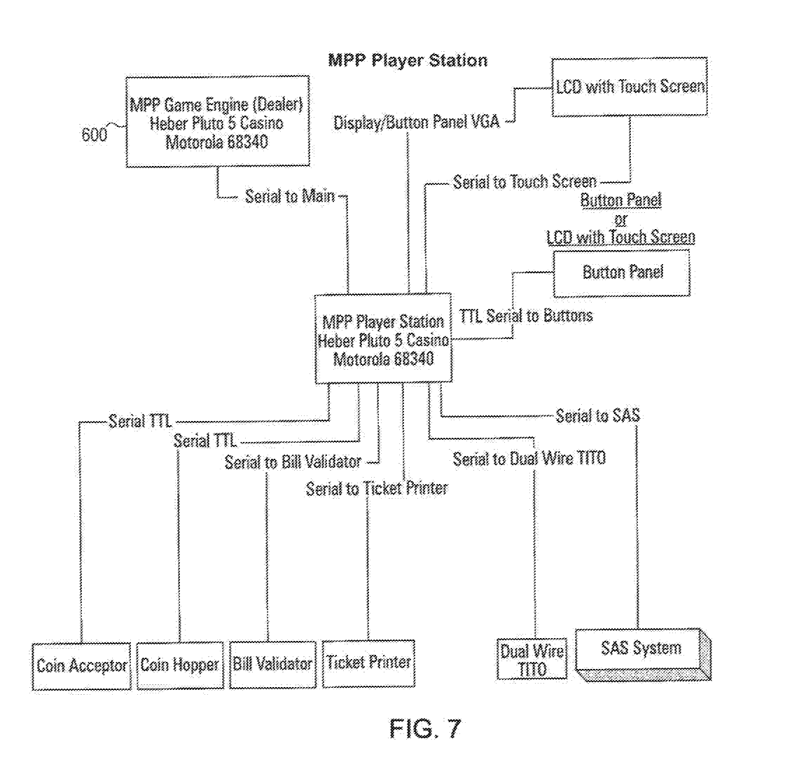

FIG. 7 shows the electronic/processing schematics of an MPP player station intelligent board (Heber Pluto 5 Casino, Motorola 68340), each of which player stations (one for each player position) is in direct connection to the MPP game engine (dealer), which is, in turn, directly connected to the PC platform (not shown in FIG. 7). Each intelligent board receives information for all player input systems specific to that player station, such as the shown coin acceptor, coin hopper, bill validator, ticket printer, touch screen, display button panel, dual wire ticket-in/ticket-out (TITO) printing system, and SAS system. (SAS is one exemplary standard communications protocol used by a number of casinos' central computer systems.)

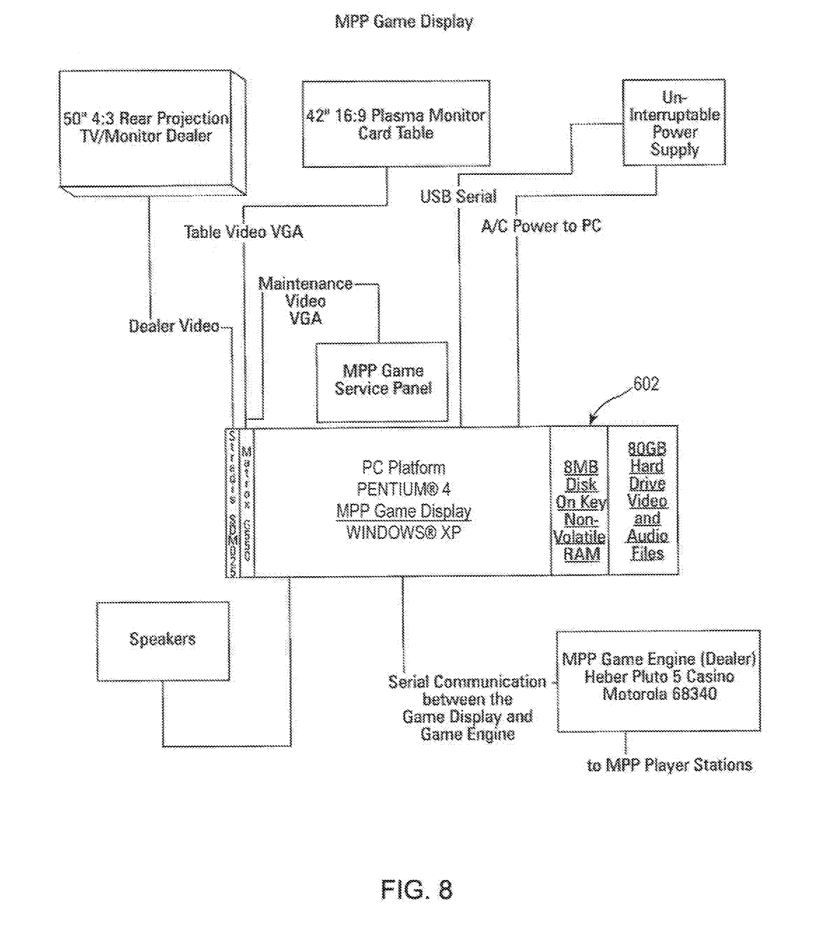

The above-described architecture is also an improvement in providing a system with not only the intelligence at each player position, but also in redistributing processing capability for functions among various processing components within the gaming system. In one architectural format, all functions of the gaming engine, except for the player localized intelligence functions, are consolidated into a single PC (e.g., the PENTIUM® 4 of FIGS. 6 and 8). This would include all game functions, player video functions, dealer video functions, dealer audio functions, security, central reporting (to a casino's central computer, for example), currency and debit functions, alarm functions, lighting functions, and all other peripheral functions on the system, except for the localized player functions. Alternatively, all functions requiring communication with the casino's main computer system are located on the player station intelligent boards. In this system, the main game processor would talk directly with the player intelligent boards, preferably in the same novel communication format described below.

An alternative system is shown in FIGS. 6, 7, and 8, wherein a dealer engine processor is intermediate the main game PC and the player intelligent boards. Both systems are a distinct improvement over the prior art, but with the higher power available for PCs and with the ease of programming a PC as opposed to an embedded system, the consolidation of the game functions and the ability of the main game engine to communicate with each of the player positions is enabled. As shown in FIG. 8, the game display processor 602 is preferably a PENTIUM® 4 PC and is separate from the main processor. With the player intelligent boards, the main game PC can receive packets of information from each player station as events occur rather than having to poll each player position on a regular basis one hundred times to gain the specific information for each player input that may be made.

For the purposes of this disclosure, it will be understood that, when a game and any actions associated with the game are described, that game and its rules and actions are also usable in an electronic version of the game (an electronic or online version of the game or games using the same set of rules and/or game play).

Gaming actions and rules, such as accepting wagers, making payouts, dealing cards, selecting cards, and other actions associated with a player or a dealer, include physical and electronic embodiments. Thus, when a description is given of a player or dealer taking a game related action, it is intended that the embodiments include action on a live gaming table, a virtual table or display, and the generation, transmission, and reception of such an action in an electronic form wherein player and dealer choices, selections, or other actions are received at an electronic interface. This further includes the results of a virtual dealer and virtual players, wherein the actions described are actually generated by a computer (typically associated with an online game). As an example, if dealing a card is described herein, the description includes providing a card to be associated (associable) with an applicable position in the game, such as a player, dealer, or a community position. Such dealing includes (but is not limited to) the following: the dealing of a card by a dealer from a deck, shuffler, or other card source and the reception or placement of the card at a table location associable with a player or the reception directly by a player; or the generation and transmission of an electronic indication of a card from a game play source or server to an electronic receiver, wherein the receiver may be at a table (virtual cards) including players and/or virtual players and/or a dealer or virtual dealer, at a public display in a casino, at a remote location (online or internet game play), or at other locations, and also including the representation of a card on a display or displays, and, if applicable to the action described, an electronic reception of an indication that the card has been received, selected, or otherwise interacted with at a location associable with a player or associated with a virtual player.

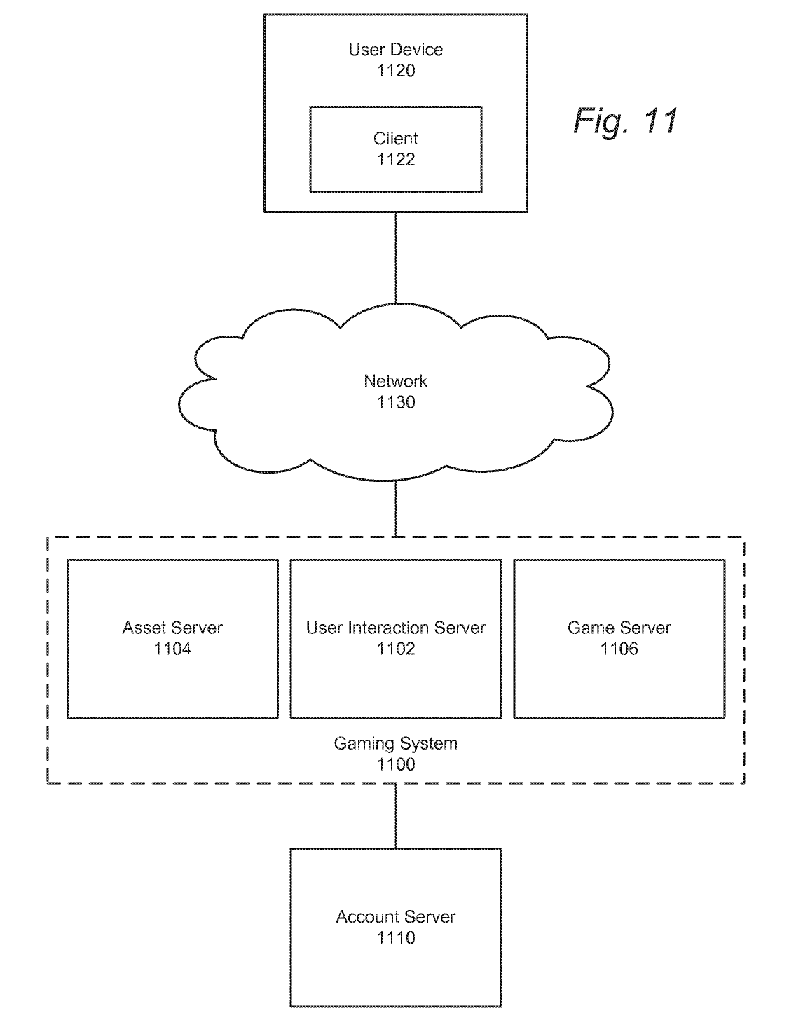

FIG. 11 is a schematic block diagram of a gaming system 1100 for implementing wagering games according to an embodiment. The gaming system 1100 enables end users to access wagering game content. Such game content may include, without limitation, various types of wagering games, such as card games, dice games, big wheel games, roulette, scratch off games, and any other wagering game with a randomized element in determining wagering outcomes. Such games may be played against the gaming system 1100 or against other end users. In particular, the gaming system 1100 allows users to play variants of the wagering games described above.

The wagering games supported by the gaming system 1100 may be operated with real currency or with virtual credits. For example, the real currency option may include traditional casino and lottery-type wagering games in which money or other items of value are wagered and may be cashed out at the end of a game session. The virtual credits option may include wagering games in which credits (or other symbols) may be issued to a player to be used for the wagers. For example, credits may be purchased by a player or issued through other methods. Although credits may be won or lost, the ability of the player to cash out the credits may be prevented. In other words, while the credits may be purchased, the credits in a “play-for-fun” option may be limited to non-monetary credits in terms of the ability of the player to extract cash, goods, or services of monetary value out of the wagering game. Systems that operate play-for-fun games may include issuance of free credits. In some embodiments, a limited number of free credits may be issued to entice players to play the games. Credits may be won or lost, but credit balances may not be cashed out. In exchange for identifying friends who may want to play, the system may issue additional credits. Often, additional credits may be issued after a period of time has elapsed to encourage the player to resume playing the game. The system may enable players to buy funds or additional game credits to allow the player to resume play. Objects of value may be awarded to play-for-fun players, which objects of value may or may not be in a direct exchange for credits. For example, the client may award a prize for a highest scoring play-for-fun player during a defined time interval.

The gaming system 1100 includes a gaming platform that establishes a portal for an end user to access a wagering game hosted by a game server 1106 through a user interaction server 1102. A user device 1120 communicates with the user interaction server 1102 of the gaming system 1100 using a network 1130. The user interaction server 1102 communicates with the game server 1106 and provides game information to the user. In some embodiments, a single user device 1120 communicates with a game provided by the game server 1106, while other embodiments may include a plurality of user devices 1120 configured to communicate and provide end users with access to the same game provided by game server 1106. In addition, a plurality of end users may access a single user interaction server 1102 or a plurality of user interaction servers 1102 to access game server 1106.

The user interaction server 1102 communicates with the user device 1120 to enable access to the gaming system 1100. The user interaction server 1102 allows a user to create and access a user account and interact with the gaming server 1106. The user interaction server 1102 allows users to initiate new games, join existing games, and interface with games being played by the user.

The user interaction server 1102 may also provide a client 1122 for execution on the user device 1120 for accessing the gaming system 1100. The client 1122 provided by the gaming system 1100 for execution on the user device 1120 can comprise a variety of implementations according to the user device 1120 and method of communication with the gaming system 1100. In one embodiment, the user device 1120 connects to the gaming system 1100 using a web browser and the client 1122 executes within a browser window or frame of the web browser. In another embodiment, the client 1122 is a stand-alone executable on the user device 1120.

For example, the client 1122 may comprise a relatively small amount of script (e.g., JAVASCRIPT®), also referred to as a “script driver,” including scripting language that controls an interface of the client 1122. The script driver may include simple function calls requesting information from the gaming system 1100. In other words, the script driver stored in the client 1122 may merely include calls to functions that are externally defined by, and executed by, the gaming system 1100. As a result, the client 1122 may be characterized as a “thin client.” As that term is used herein, the client 1122 may be little more than a script player. The client 1122 may simply send requests to the gaming system 1100 rather than performing logic itself. The client 1122 receives player inputs, and the player inputs are passed to the gaming system 1100 for processing and executing the wagering game. In other embodiments, the client 1122 comprises an executable rather than a script. As a result, the bulk of the processing of the game play is performed in the gaming system 1100. The client 1122 may receive intermediate data and final game outcome information from the gaming system 1100 for displaying on the end user's computer after such intermediate data and final game outcome information are determined by the game server 1106.

In another embodiment, the client 1122 implements further logic and game control methodology beyond the thin client described above. For example, the client 1122 may parse and define player interactions prior to passing the player interactions to the gaming system 1100. Likewise, when the client 1122 receives a gaming interaction from the gaming system 1100, the client 1122 may be configured to determine how to modify the display as a result of the gaming interaction. The client 1122 may also allow the player to change a perspective or otherwise interact with elements of the display that do not change aspects of the game.

The gaming system 1100 also includes an asset server 1104, which hosts various media assets (e.g., audio, video, and image files) that may be sent to the client 1122 for presenting the various wagering games to the end user. In other words, in this embodiment the assets presented to the end user are stored separately from the client 1122, and the client 1122 requests the assets appropriate for the game played by the user. For example, the client 1122 may call a function defined at the user interaction server 1102 or asset server 1104, which determines what assets are to be delivered to the client 1122 as well as how the assets are to be presented by the client 1122 to the end user. Different assets may correspond to the various clients that may have access to the game server 1106 or to different games to be played.

The game server 1106 is configured to perform game play methods and to determine game play outcomes that are provided to the user interaction server 1102 to be transmitted to the user device 1120 for display on the end user's computer. For example, the game server 1106 may include game rules for one or more wagering games, such that the game server 1106 controls the game flow for a selected wagering game, as well as the determined game outcomes, pay tables, and other game logic. The game server 1106 also performs random number generation for determining random game elements of the wagering game. The game server 1106 is typically separated from the user interaction server 1102 by a firewall or other method of preventing unauthorized access to the game server 1106 from the general members of the network 1130.

The user device 1120 presents a gaming interface to the player and communicates the user interaction to the gaming system 1100. The user device 1120 may be any electronic system capable of displaying gaming information, receiving user input, and communicating the user input to the gaming system 1100. As such, the user device 1120 can be a desktop computer, a laptop, a tablet computer, a set-top box, a mobile device, a kiosk, a terminal, or another computing device. The user device 1120 operates the client 1122 for connecting to the interactive gaming system 1100, as described above. The client 1122 may be a specialized application or may be executed within a generalized application capable of interpreting instructions from the interactive gaming system 1100, such as a web browser.

The client 1122 may interface with an end user through a web page, an application (e.g., a smartphone or tablet application), or another computer program in order to access the gaming system 1100. The client 1122 may be illustrated within a casino webpage (or other interface) indicating that the client 1122 is embedded into a webpage, which is supported by a web browser executing on the client user device 1120.

The gaming system 1100 may be operated by different entities in one embodiment. The user device 1120 may be operated by a third party, such as a casino, that links to the gaming system 1100. Therefore, in some embodiments, the user device 1120 and the client 1122 are operated by a different administrator than the operator of the game server 1106. In other words, the user device 1120 may be part of a third-party system that does not administer the game server 1106. In another embodiment, the user interaction server 1102 and the asset server 1104 are provided by a third-party system. For example, a gaming entity (e.g., a casino) may operate the user interaction server 1102 or the user device 1120 to provide its customers access to game content managed by a different entity. In some embodiments, these functions are operated by the same administrator. For example, a gaming entity (e.g., a casino) may elect to perform each of these functions in-house, such as providing both the access to the user device 1120 and the actual game content and providing administration of the gaming system 1100.

The gaming system 1100 also communicates with external account servers 1110, optionally through another firewall. For example, the gaming system 1100 itself may not take wagers or issue payouts. In other words, the gaming system 1100 may facilitate online casino gaming, but may not be part of a self-contained online casino itself. Instead, the gaming system 1100 may facilitate the play of proprietary card game content owned and controlled by a company offering games, gaming products, and gaming services, such as Shuffle Master, Inc. Another entity (e.g., a casino) may operate and maintain its external account servers 1110 to take bets and make payout distributions. The gaming system 1100 may communicate with the account servers 1110 to verify the existence of funds for wagering, and the gaming system 1100 instructs the account servers 1110 to execute debits and credits.

In some embodiments, the gaming system 1100 may take bets and make payout distributions, such as in the case where an administrator of the gaming system 1100 operates as a casino. As discussed above, the gaming system 1100 may be integrated within the operations of a casino rather than separating out functionality (e.g., game content, game play, credits, debits, etc.) among different entities. In addition, for play-for-fun wagering games, the gaming system 1100 may issue credits, take bets, manage the balance of the credits according to the game outcomes, but may not permit payout distributions or be linked to play-for-fun account servers 1110 that permit payout distributions. Such credits may be issued for free, through purchase, or for other reasons, without the ability for the player to cash out. Such play-for-fun wagering games may be played on platforms that do not permit traditional gambling, such as to comply with jurisdictions that do not permit online gambling.

The gaming system 1100 may be configured using a distributed server architecture. For example, the game server 1106 may include a plurality of servers (e.g., a game rules server, a deck server, a game routing server, an account server, an asset server, etc.) that are logically separated to perform different functions for the wagering game. Additional features may be supported by the game server 1106, such as hacking and cheating detection, data storage and archiving, metrics generation, messages generation, output formatting for different end user devices, as well as other features and operations. For example, the gaming system 1100 may include additional features and configurations as described in U.S. patent application Ser. No. 13/609,031, filed Sep. 10, 2012, entitled “Network Gaming Architecture, Gaming Systems, and Related Methods,” the entire disclosure of which is incorporated herein by this reference.

The network 1130 enables communications between the user device 1120 and the gaming system 1100. A network (not shown) may also connect the gaming system 1100 and the account server 1110. In one embodiment, the network 1130 uses standard communications technologies and/or protocols. Thus, the network 1130 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 1130 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1130 can be represented using technologies and/or formats including the hypertext markup language (HTML), the extensible markup language (XML), etc. In addition, all or some of links can be encrypted using conventional encryption technologies, such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 1130 can also include links to other networks, such as the Internet.

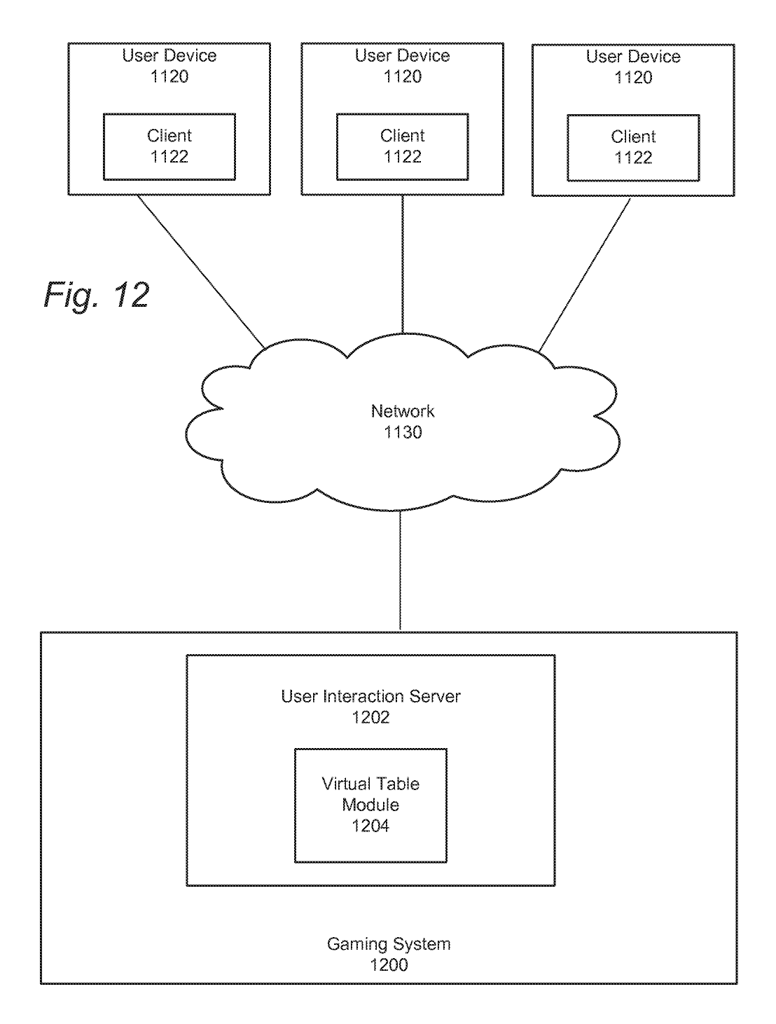

FIG. 12 illustrates a block diagram of a gaming system 1200 that offers wagering games according to one embodiment. The gaming system 1200 provides gaming services to a plurality of user devices 1120 in a similar manner to the gaming system 1100 described above with respect to FIG. 11. Accordingly, common components between the gaming system 1200 of FIG. 12 and the gaming system 1100 of FIG. 11 may include the asset server 1104, the game server 1106, and a communication with the account server 1110. A user interaction server 1202 provides similar functionality to the user devices 1120 as provided by the user interaction server 1102 (FIG. 11). The user interaction server 1202 includes additional functionality using a virtual table module 1204 for providing a virtual table to the user devices 1120.

The virtual table module 1204 creates and manages virtual tables for use by the user devices 1120. A virtual table is a simulation of a table as may be used on a casino floor. As such, the virtual table allows a specific number of players to join a game hosted by the gaming system 1200. The game may be operated by the game server 1106 (FIG. 11). A lobby may be provided to the player of the user device 1120, allowing the user to browse various tables that may be joined by the player. Once a player joins a virtual table, the virtual table module 1204 provides a virtual table interface to the user device 1120.

The virtual table interface provided by the virtual table module 1204 displays appropriate play areas to the user according to the game being played by the user. For example, a user choosing to play a game as described above, and shown with respect to FIG. 9, may be shown play areas for multiple players in the game. To take particular actions relative to the action in the game, the player takes action in gameplay areas associated with the particular player. In addition, when the dealer takes actions, the dealer's actions are relayed to each of the other players. In certain games, a player may take actions in the game simultaneously, and, in others, the player must wait for the game's action to be on the player before the player may act. The virtual table interface provides the user the ability to view virtual actions taken by other players in addition to actions taken by the player himself Using the virtual table module 1204, the gaming system 1200 provides a virtual experience to the user similar to play on a casino floor.

In addition to actions taken responsive to the gameplay, players may also view other information provided by the other players. For example, like sitting at a table in person, the players at the virtual table may chat with one another, for example via a chat interface, and optionally communicate with an audio connection if a microphone and speakers are available at the user devices 1120. In addition, for games in which a player is provided a card or cards face down, the player may also choose to reveal the player's card(s) to the other players at the table. Thus, the virtual table enables the players to engage in interactions with others players at the table as though the players were actually in person together at a table at the casino floor.

In one embodiment, the virtual table module 1204 provides the players with an image of a virtual dealer. The virtual dealer provides interaction with the various players of the game, indicating, for example, when it is a player's turn to take an action. The user interface for each player may be customized for each player's perspective at the virtual table. For example, the player at the first seat at the table is provided a view different from the view provided to the second seat, the third seat, etc. As such, each player may have a different view of the table, as well as a different perspective on the virtual dealer. Thus, when the virtual dealer is indicating that the second seat must act in the game, to the player in the second seat the perspective indicates the virtual dealer is gesturing to that player, while a player in the first seat is provided a different perspective of the virtual dealer indicating to the second seat.

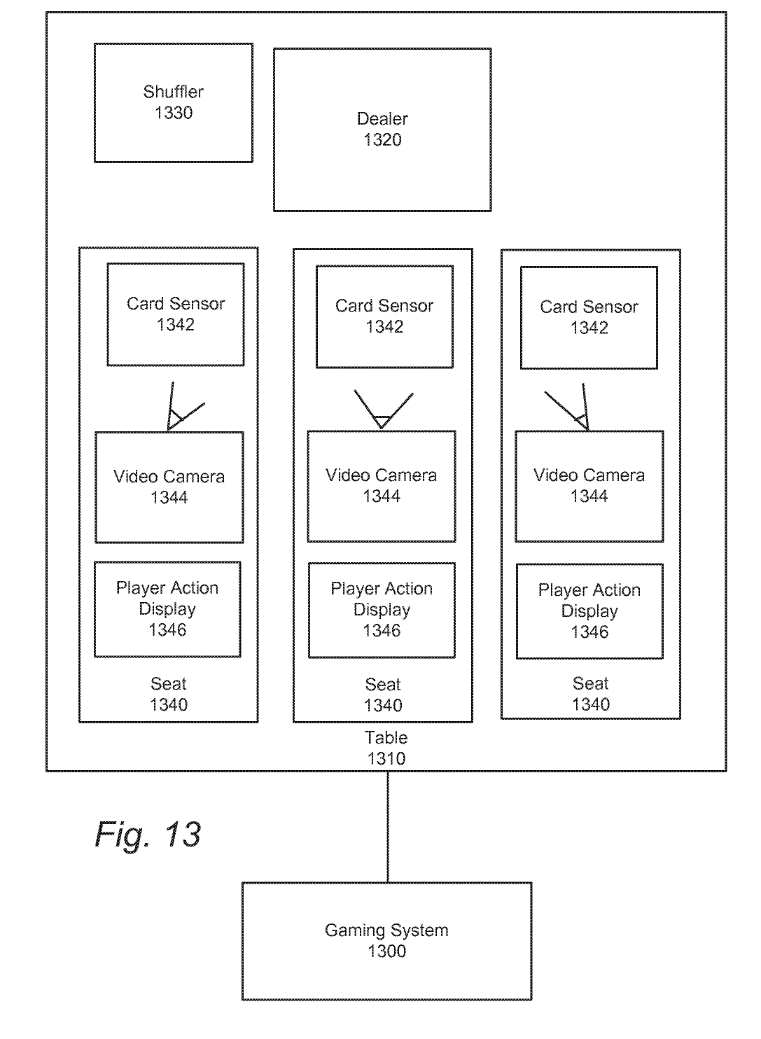

FIG. 13 is a block diagram of a gaming system 1300 providing for live dealer play for a user at a remote user device, according to one embodiment. In this embodiment, the wagering games described herein are provided to a player on a user device (not shown) by a live dealer 1320 at a table 1310. In this embodiment, the live dealer 1320 and the table 1310 provide the game engine functionality to the gaming system 1300 by executing game mechanics and providing game action and results to the gaming system 1300. The live dealer 1320 receives cards from a shuffler 1330 and distributes the cards to players according to the gameplay rules. When players join and leave the game, players join a seat 1340 at the table 1310. The table 1310 includes the number of seats 1340 according to the number of seats 1340 allotted to the particular game being played.

In this embodiment, each of the seats 1340 at the table 1310 includes a card sensor 1342, a video camera 1344, and a player action display 1346. The player at one of the seats 1340 is provided a view of the table 1310 from the video camera 1344. The video camera 1344 provides a video feed to the user device operated by the player, showing the player action on the table 1310 and provides the player a view of the dealer 1320 and the shuffler 1330. Thus, the player receives a live view of activities at the table 1310 while the user plays the game.

The card sensor 1342 includes positions for the dealer 1320 to place cards as the cards are dealt to the dealer 1320. The card sensor 1342 may be in view of the video camera 1344, or the card sensor 1342 may not be in view of the video camera 1344. When the card sensor 1342 is in view of the video camera 1344, the dealer 1320 may deal the cards to the positions face up so the video camera 1344 may view the cards dealt to the player. When the card sensor 1342 is not viewable by the player, the card sensor 1342 may be placed underneath the video camera 1344 and provide the illusion that the dealer 1320 is providing cards to the player, as the cards are dealt underneath the video camera 1344 and leave the video camera's 1344 view. The cards dealt to the player are transmitted to the gaming system 1300 and subsequently to the user device and displayed to the player. The particular cards dealt to the player may be determined in various ways. In one embodiment, the shuffler 1330 includes a card reader that identifies particular rank and suit (and any other relevant characteristics) of a card as the card leaves the shuffler 1330. The shuffler 1330 may also know the seat 1340 to which the card will be dealt. As such, the shuffler 1330 may provide the card information to the gaming system 1300. When the card is dealt to the seat 1340, the card sensor 1342 detects the presence of the card (e.g., by blocking light to a sensor at the card position). The card sensor 1342 indicates the presence of the card to the shuffler 1330, and the shuffler 1330 indicates, to the gaming system 1300, the card provided to the seat 1340.

Alternatively, the card sensor 1342 may detect the rank and suit of the card. The card sensor 1342 identifies the cards by a variety of means. In one embodiment, the card sensor 1342 comprises a translucent panel placed over a scanner. When a card is played over the card sensor 1342, the scanner reads the card through the translucent panel and provides the card information to the gaming system 1300. In another embodiment, the card sensor 1342 includes a radio-frequency identification (RFID) reader (or interrogator). In this embodiment, each card includes an RFID tag responsive to the RFID reader, the tag indicating the card's rank and suit when interrogated by the RFID reader. When the dealer 1320 places the card on the position of the card for the seat 1340, the RFID reader interrogates the RFID tag in the card and obtains the card's characteristics. The card's characteristics are provided to the gaming system 1300 for communication with the user device of the player at the seat 1340. Other card identification methods may be used by the card sensor 1342 to identify the card placed at the seat 1340.

The seat 1340 also includes the player action display 1346. As players place wagers and execute game actions on the respective user devices, the players' activities are transmitted to the player action display 1346. The player action display 1346 is a visual display, for the dealer 1320, of the player's action. For example, the player action display 1346 may indicate when a user has placed a bet, folded, or interacted with the game according to actions permitted by the game rules. In one embodiment, the player action display 1346 also provides a video feed, to the dealer 1320, of a camera at the user device. The camera may be used to show, for example, the user as the user plays the game, thus enabling a face-to-face view of the player to the dealer 1320, though the player is not at the table 1310. In one embodiment, the player action display 1346 shows the amount of time since a user has taken an action. The amount of time since the user has taken an action is used by the dealer 1320 to determine whether to wait for the player or whether to continue with play when the player has been idle. The player actions may also be shown to each user device to indicate the actions taken by other players during the game.

The shuffler 1330 is an automatic card shuffler that shuffles cards for the game being played. The shuffler 1330 includes, in one embodiment, a card reader that indicates individual cards or groups of cards as the cards are dealt by the shuffler 1330. The shuffler 1330 may also be programmed for the rules of the game being dealt and may be able to determine, for example, the particular cards to be dealt to individual players. The shuffler 1330 provides the card information to the gaming system 1300. Thus, the gaming system 1300, using the table 1310, allows a user to be remotely located at a user device while maintaining a live casino feel by viewing action at the table 1310. Since actual cards are shuffled by the shuffler 1330 and the dealer 1320 deals the cards, the user is able to enjoy a live game playing format. The dealt cards are provided to the user device operated by the user, and the user's actions are provided to the table 1310 by the player action display 1346. The dealer 1320 uses the player action display 1346 to determine what actions to take to complete the game. Because the player has a view of the dealer 1320, the dealer 1320 can also interact directly with players and respond to particular players. For example, the dealer 1320 may gesture to a particular player that it is that player's turn to perform an action in the game. In addition, the user may communicate with the dealer 1320, either by speaking to the dealer 1320 using a microphone or by providing a message to the dealer 1320 through the player action display 1346. For example, a player who does not know how to play the game may type a query into the user device, the query may appear in the player action display 1346, and the dealer 1320 may explain the game rules to the video camera 1344 of the seat 1340 for the player requesting the information. Thus, players can play the wagering games of this description in an environment simulating live play.

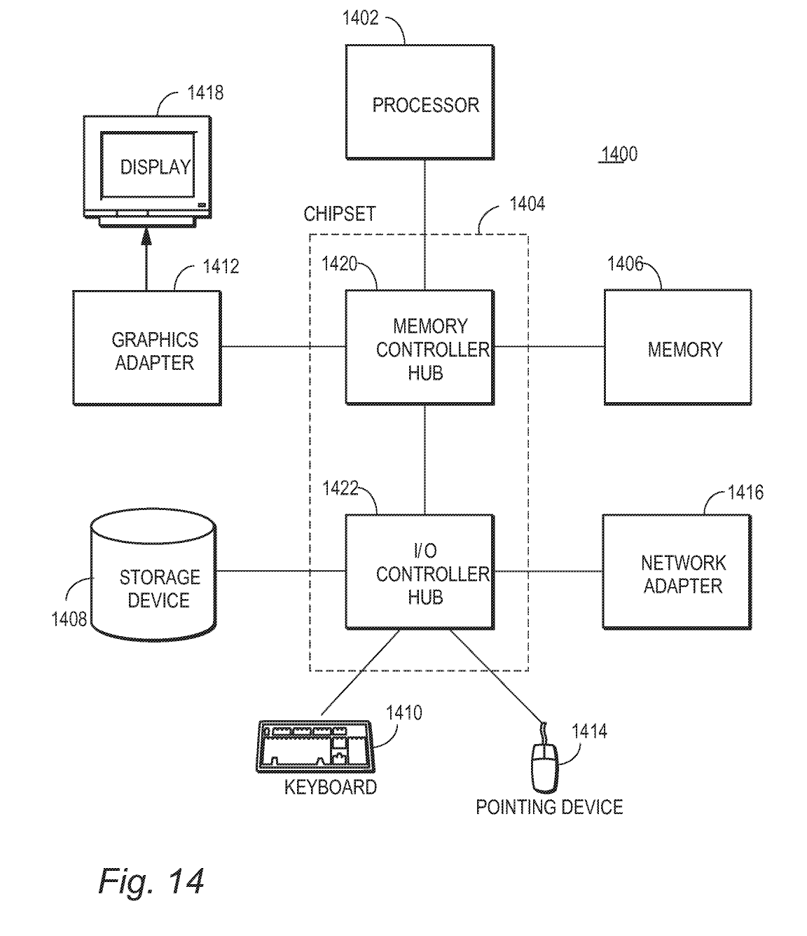

FIG. 14 is a high-level block diagram of a computer 1400 for acting as the gaming system 1100 (FIG. 11), 1200 (FIG. 12), or 1300 (FIG. 13) according to one embodiment. Illustrated are at least one processor 1402 coupled to a chipset 1404. Also coupled to the chipset 1404 are memory 1406, a storage device 1408, a keyboard 1410, a graphics adapter 1412, a pointing device 1414, and a network adapter 1416. A display 1418 is coupled to the graphics adapter 1412. In one embodiment, the functionality of the chipset 1404 is provided by a memory controller hub 1420 and an I/O controller hub 1422. In another embodiment, the memory 1406 is coupled directly to the processor 1402 instead of to the chipset 1404.

The storage device 1408 is any non-transitory computer-readable storage medium, such as a hard drive, compact disc read-only memory (CD-ROM), a DVD, or a solid-state memory device. The memory 1406 holds instructions and data used by the processor 1402. The pointing device 1414 may be a mouse, a track ball, or another type of pointing device, and is used in combination with the keyboard 1410 to input data into the computer 1400. The graphics adapter 1412 displays images and other information on the display 1418. The network adapter 1416 couples the computer 1400 to a local or wide area network.

The computer 1400 can have different and/or other components than those shown in FIG. 14. In addition, the computer 1400 can lack certain illustrated components. In one embodiment, the computer 1400 acting as a gaming system lacks the keyboard 1410, the pointing device 1414, the graphics adapter 1412, and/or the display 1418. Moreover, the storage device 1408 can be local and/or remote from the computer 1400 (such as embodied within a storage area network (SAN)).

A gaming system may comprise several such computers 1400. The gaming system may include load balancers, firewalls, and various other components for assisting the gaming system to provide services to a variety of user devices.

The computer 1400 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 1408, loaded into the memory 1406, and executed by the processor 1402.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient, at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise, as apparent from the following discussion, it is appreciated that, throughout the description, discussions utilizing terms such as “processing,” “computing,” “calculating,” “determining,” “displaying,” or the like refer to the actions and processes of a computer system, or similar electronic computing device (such as a specific computing machine), that manipulates and transforms data represented as physical (electronic) quantities within the computer system memories, registers, or other such information storage, transmission, or display devices.

Certain aspects of the embodiments include process steps and instructions described herein in the form of an algorithm. It should be noted that the process steps and instructions of the embodiments can be embodied in software, firmware, or hardware, and, when embodied in software, could be downloaded to reside on and be operated from different platforms used by a variety of operating systems. The embodiments can also be in a computer program product that can be executed on a computing system.

The embodiments also relate to an apparatus for performing the operations herein. This apparatus may be specially constructed for its purposes, e.g., a specific computer, or it may comprise a general-purpose computer selectively activated or reconfigured by a computer program stored in the computer. Such a computer program may be stored in a computer-readable storage medium, such as, but not limited to, any type of disk, such as floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, wherein a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

In addition, the language used in the specification has been principally selected for readability and instructional purposes and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A multiplayer platform gaming system, comprising:
a game display processor in direct operable communication with speakers and a monitor card display;
a game engine processor in operative communication with the game display processor; and
a plurality of player station intelligence boards in direct connection with the game engine processor, each player station intelligence board of the plurality being in operative communication with at least one input device of a player input system associated with a player station of a plurality of player stations of the multiplayer platform gaming system; and
the multiplayer platform gaming system configured to perform a combination of executions, comprising:
after receipt, by one of the player station intelligence boards of the plurality of player station intelligence boards, of an electronic indication for ante and a blind, the game display processor directing display of values for two hole cards for a player hand;
after display of the values for the two hole cards for the player hand, administering a plurality of play election events, each of the play election events comprising:
at initiation of the play election event, no prior receipt of an indication for a play multiple of the ante;
receiving, by the one of the player station intelligence boards, an election selected, by a player during the play election event, from options consisting of:
the play multiple of the ante not exceeding a limit that lowers with each successive administration of the play election events of the plurality of play election events, and
one of a check option and a fold option, the one of the check option and the fold option being the check option for each of the play election events before a final play election event of the plurality of play election events and being the fold option for the final play election event,
wherein the play multiple is receivable only once during administration of the plurality of play election events,
wherein each of the play election events except for the final play election event is followed by the game display processor directing display of values of community cards available for the player hand and for a dealer hand, and
wherein the final play election event is administered after values of all cards available for the player hand have been displayed where viewable by the player; and
the game engine processor resolving all received of the ante, the blind, and the play multiple based at least in part on the player hand and the dealer hand.

2. The multiplayer platform gaming system of claim 1, wherein the game display processor is separate from the game engine processor.

3. The multiplayer platform gaming system of claim 1, wherein the game engine processor is configured to receive packets of information from each player station intelligence board of the plurality of player station intelligence boards, as events occur in performing the combination of executions, without polling each of the player station intelligence boards on a regular basis.

4. The multiplayer platform gaming system of claim 1, wherein the limit for the play multiple of the ante is at least three times the ante for an initial play election event of the plurality of play election events.

5. The multiplayer platform gaming system of claim 4, wherein the limit for the play multiple of the ante is two times the ante for an intermediate play election event of the plurality of play election events.

6. The multiplayer platform gaming system of claim 5, wherein the limit for the play multiple of the ante is one times the ante for the final play election event of the plurality of play election events.

7. A method of operating a computer system to generate random hands of cards and resolve a poker-based event, the computer system comprising a game display processor, a game engine processor in operative communication with the game display processor, and at least one user station intelligence board in direct operable communication with the game engine processor, the method comprising:
operating the computer system in a round of the method according to a combination of steps, the combination of steps comprising the following, in order as indicated:
the game engine processor receiving, from the at least one user station intelligence board, an indication for an ante and for a blind to enter a user of the computer system into the round of the method;
the game display processor directing display, on a monitor card display of the computer system, of two initial cards for a user hand;
administering an initial election event, comprising the game engine processor receiving, from the at least one user station intelligence board, an initial election selected by the user, during the round, from options consisting of:
a check option, and
a play option, the play option of the initial election event being at least three times the ante;
the game display processor directing display, on the monitor card display of the computer system, of three community cards available for the user hand and for an administrator hand;
administering an intermediate election event, comprising the game engine processor receiving, from the at least one user station intelligence board, an intermediate election selected by the user, during the round, from options consisting of:
another check option, and
the play option, the play option of the intermediate election event being two times the ante;
the game display processor directing display, on the monitor card display of the computer system, of final cards available for the user hand and for the administrator hand, the final cards available for the user hand and for the administrator hand being two additional community cards;
administering a final election event, comprising the game engine processor receiving, from the at least one user station intelligence board, a final election selected by the user, during the round, from options consisting of:
a fold option, and
the play option, the play option of the final election event being equal to the ante; and
the game engine processor resolving all received of the ante, the blind, and the play option, based at least in part on the user hand and the administrator hand,
wherein the play option is receivable in only one of the initial election event, the intermediate election event, and the final election event.

8. The method of claim 7, wherein the ante and the blind are equal in amount.

9. The method of claim 7, wherein the administrator hand consists of five cards selected by the game engine processor from the three community cards, the two additional community cards, and two other cards available for only the administrator hand.

10. The method of claim 9, wherein the combination of steps further comprises, before administering the initial election event, the game display processor directing display, on the monitor card display of the computer system, of the two other cards available for the administrator hand as face-down cards.

11. The method of claim 10, wherein the combination of steps further comprises, after administering the final election event and before the game engine processor resolves all received of the ante, the blind, and the play option, the game display processor directing display, on the monitor card display of the computer system, of the two other cards available for the administrator hands as face-up cards revealing values thereof.

12. The method of claim 9, wherein the user hand consists of five cards selected by the user from the two initial cards, the three community cards, and the two additional community cards.

13. A computer-implemented system to support administration of an interactive game wherein intra-game wager amounts are related to game information imparted to a user, the system comprising:
an interactive server;
one or more user devices each comprising an input device and a video display;
a communication network to provide communication between the interactive server and each of the user devices;
one or more non-transitory machine-readable storage media having instructions stored therein that, when executed by the interactive server, cause the interactive server to implement an ordered combination of instructions, as follows:
(i) receive an ante wager, input at one of the user devices, to indicate participation by a user in a round of the interactive game;
(ii) control the video display to display a representation of:
two cards face up for a user hand associated with the user; and
two cards face down for a dealer hand;
(iii) control the video display to display a menu of first user options of an initial play election event, the first user options consisting of:
a check, and
a first play wager against the dealer hand, the first play wager being an amount not greater than a first multiple of the ante wager;
(iv) after receipt, from the one of the user devices, of a first user election from the first user options, control the video display to display a representation of three community cards face up and available for the user hand and for the dealer hand;
(v) control the video display to display a menu of second user options of an intermediate play election event, the second user options consisting of:
another check, and
a second play wager against the dealer hand, the second play wager being an amount not greater than a second multiple of the ante wager, the second multiple being less than the first multiple;
(vi) after receipt, from the one of the user devices, of a second user election from the second user options, control the video display to display a representation of two more community cards face up and available for the user hand and for the dealer hand; and
(vii) resolve at least the ante wager based on the user hand and the dealer hand according to poker rankings.

14. The computer-implemented system of claim 13, wherein the ordered combination of instructions, when implemented by the interactive server, further cause the interactive server to, when resolving at least the ante wager, determine a five-card poker rank of the dealer hand,
the dealer hand consisting of five cards selected from:
the two cards face down for the dealer hand, the three community cards face up and available for the user hand and for the dealer hand, and
the two more community cards face up and available for the user hand and for the dealer hand.

15. The computer-implemented system of claim 13, wherein the ordered combination of instructions, when implemented by the interactive server, further cause the interactive server to:
before controlling the video display to display the representation of the two cards face up for the user hand associated with the user, receive a blind wager, input at the one of the user devices, to indicate participation by the user in a blind event of the round of the interactive game; and
before, after, or while resolving at least the ante wager, resolve the blind wager, comprising comparing the user hand to a predetermined blind event pay table, the user hand consisting of five cards selected from:
the two cards face up for the user hand,
the three community cards face up and available for the user hand and for the dealer hand, and
the two more community cards face up and available for the user hand and for the dealer hand.

16. The computer-implemented system of claim 13, wherein the ordered combination of instructions, when implemented by the interactive server, further cause the interactive server to:
before controlling the video display to display the representation of the two cards face up for the user hand associated with the user, receive a side wager, input at the one of the user devices, to indicate participation by the user in a side event of the round of the interactive game; and
before, after, or while resolving at least the ante wager, resolve the side wager, comprising distributing a side payout for the user hand having a poker ranking of a three-of-a-kind or better, the user hand consisting of five cards selected from:
the two cards face up for the user hand,
the three community cards face up and available for the user hand and for the dealer hand, and
the two more community cards face up and available for the user hand and for the dealer hand.

17. The computer-implemented system of claim 13, wherein the first multiple of the ante wager is at least 3×.

18. The computer-implemented system of claim 17, wherein the second multiple of the ante wager is 2×.

19. The computer-implemented system of claim 13, wherein the ordered combination of instructions, when implemented by the interactive server, further cause the interactive server to:
after controlling the video display to display the representation of the two more community cards and before resolving at least the ante wager, control the video display to display a menu of third user options of a final play election event, the third user options consisting of:
a fold to forfeit the ante wager, and
a third play wager against the dealer hand, the third play wager being an amount not greater than a third multiple of the ante wager.

20. The computer-implemented system of claim 19, wherein the third multiple of the ante wager is 1×.
